(19) United States
(12) Patent Application Publication
(10) Pub. No.: US 2026/0128604 A1
(43) Pub. Date: May 7, 2026

(54) POWER SUPPLY SYSTEM

(71) Applicant: TOYOTA JIDOSHA KABUSHIKI KAISHA, Toyota-shi (JP)

(72) Inventor: Satoshi ICHIDA, Susono-shi (JP)

(73) Assignee: TOYOTA JIDOSHA KABUSHIKI KAISHA, Toyota-shi (JP)

(21) Appl. No.: 19/361,498

(22) Filed: Oct. 17, 2025

(30) Foreign Application Priority Data
Nov. 1, 2024 (JP) 2024-193181

(51) Int. Cl. H02J 7/00; B60L 53/22; B60L 53/24

(52) U.S. Cl. CPC H02J 7/56; B60L 53/22; B60L 53/24; H02J 7/80; H02J 7/855; H02J 2207/50

(57) ABSTRACT

The power supply system includes: a first inverter connected to the first battery via a first positive electrode line and a negative electrode line; a second inverter connected to the second battery via a second positive electrode line and the negative electrode line; a first capacitor connected to the first positive electrode line and the negative electrode line; a second capacitor connected to the second positive electrode line and the negative electrode line; a negative electrode connection relay capable of disconnecting and connecting the negative electrode of the second battery and the negative side power supply line of the second inverter; a charging connector; and a control device for turning on the negative electrode connection relay.

### CROSS-REFERENCE TO RELATED APPLICATION

This application claims priority to Japanese Patent Application No. 2024-193181 filed on November 1, 2024. The disclosure of the above-identified application, including the specification, drawings, and claims, is incorporated by reference herein in its entirety.

### BACKGROUND

### 1. Technical Field

The present disclosure relates to a power supply system.

### 2. Description of Related Art

There has been proposed a drive device including first and second power storage devices, a motor including a three-phase coil, and first and second inverters (see Japanese Unexamined Patent Application Publication No. 2020-5394 (JP 2020-5394 A), for example). The first and second inverters are connected to first and second power lines to which the first and second power storage devices are connected, are connected to one end side and the other end side of the three-phase coil, and have a plurality of first and second switching elements.

### SUMMARY

The power supply system includes a motor including a three-phase coil, a first inverter, a second inverter, a first capacitor, and a second capacitor. The first inverter is connected to a first battery via a first positive electrode line and a first negative electrode line, and is connected to one end side of the three-phase coil. The second inverter is connected to a second battery via a second positive electrode line and a second negative electrode line, and is connected to another end side of the three-phase coil. The first capacitor is connected to the first positive electrode line and the first negative electrode line. The second capacitor is connected to the second positive electrode line and the second negative electrode line. In such a power supply system, it is recognized as an important issue to execute stable discharge of the first capacitor or the second capacitor.

A main object of the power supply system of the present disclosure is to execute stable discharge of the first capacitor or the second capacitor.

In order to achieve the above main object, the power supply system of the present disclosure adopts the following measures. A first aspect of the present disclosure provides a power supply system including a first battery and a second battery, the power supply system including:

a motor including a three-phase coil;

a first inverter connected to the first battery via a first positive electrode line and a negative electrode line and connected to one end side of the three-phase coil;

a second inverter connected to the second battery via a second positive electrode line and the negative electrode line and connected to another end side of the three-phase coil;

a first capacitor connected to the first positive electrode line and the negative electrode line;

a second capacitor connected to the second positive electrode line and the negative electrode line;

a negative electrode connection relay that is attached to the negative electrode line and that enables and disables connection between a negative electrode terminal of the second battery and a negative side power supply line of the second inverter;

a charging connector connected to the first positive electrode line and the negative electrode line and electrically connectable to a charging facility; and

a control device that turns on the negative electrode connection relay when discharging the first capacitor or the second capacitor.

In the thus configured power supply system according to the first aspect of the present disclosure, it is possible to execute stable discharge of the first capacitor or the second capacitor.

A second aspect of the present disclosure provides a power supply system including a first battery and a second battery, the power supply system including:

a motor including a three-phase coil;

a first inverter connected to the first battery via a first positive electrode line and a negative electrode line and connected to one end side of the three-phase coil;

a second inverter connected to the second battery via a second positive electrode line and the negative electrode line and connected to another end side of the three-phase coil;

a first capacitor connected to the first positive electrode line and the negative electrode line;

a second capacitor connected to the second positive electrode line and the negative electrode line;

a positive electrode connection relay attached to a positive electrode connection line that connects the first positive electrode line and the second positive electrode line;

a negative electrode connection relay that is attached to the negative electrode line and that enables and disables connection between a negative electrode terminal of the second battery and a negative side power supply line of the second inverter;

a first positive electrode relay that is attached to the first positive electrode line and that enables and disables connection between the first battery and the first inverter and the first capacitor;

a second positive electrode relay that is attached to the second positive electrode line and that enables and disables connection between the second battery and the second inverter and the second capacitor;

a charging connector connected to the first positive electrode line and the negative electrode line and electrically connectable to a charging facility; and

a control device that turns off the first and second positive electrode relays and turns on the positive electrode connection relay and the negative electrode connection relay when discharging the first capacitor and the second capacitor.

In the thus configured power supply system according to the second aspect of the present disclosure, it is possible to execute stable discharge of the first and second capacitors.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a power supply system and a charging station according to an embodiment of the present disclosure;

FIG. 2 is an explanatory diagram showing a current path during parallel charging;

FIG. 3 is a flowchart illustrating an example of a processing routine;

FIG. 4 is an explanatory view showing a path of a current;

FIG. 5 is an explanatory view showing a current path; and

FIG. 6 is an explanatory diagram illustrating an example of a current path.

### DETAILED DESCRIPTION OF EMBODIMENTS

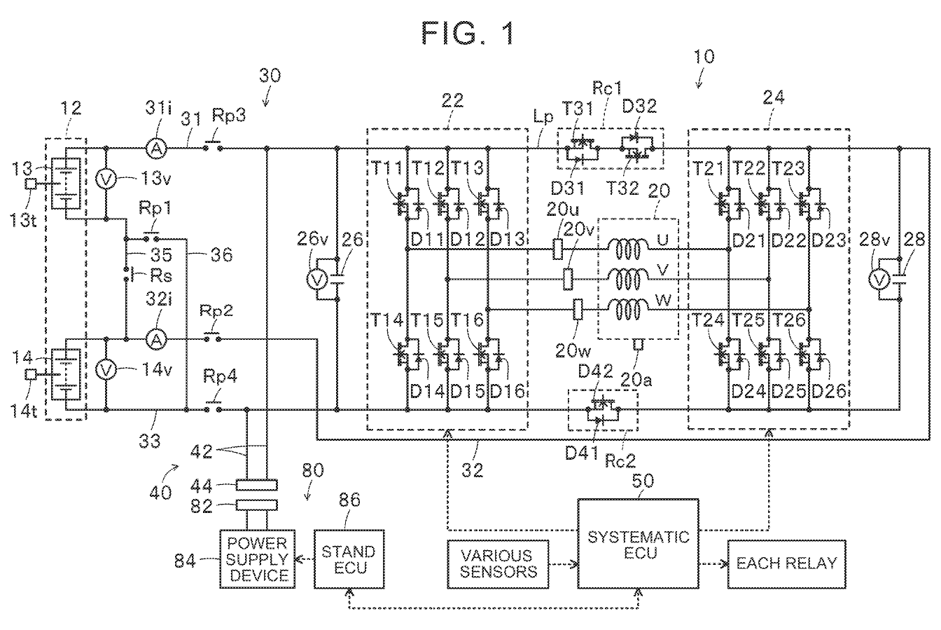

Embodiments for carrying out the present disclosure will be described with reference to the drawings. FIG. 1 is a schematic configuration diagram of a power supply system and a charging station according to an embodiment of the present disclosure. The power supply system 10 is mounted on a battery electric vehicle or a hybrid electric vehicle. The power supply system 10 includes a battery 12, a motor 20, a first inverter 22, a second inverter 24, a switching circuit 30, a charging circuit 40, and a system electronic control unit 50 as a control device. The electronic control unit for the system is hereinafter referred to as "system ECU". The power supply system 10 is capable of charging the battery 12 using electric power from a charging station (charging facility) 80 provided at a home, a charging station, or the like.

The battery 12 includes a first battery 13 and a second battery 14 as a first battery and a second battery. The first battery 13 and the second battery 14 are each configured as, for example, a lithium-ion secondary battery or a nickel-hydrogen secondary battery whose rated voltage is slightly lower than the first voltage Vs1 (for example, 400V). In the embodiment, the first battery 13 and the second battery 14 have the same specifications. The positive electrode terminal of the first battery 13 is connected to the first positive electrode line 31, and the negative electrode terminal of the second battery 14 is connected to the negative electrode line 33 and is connected to the vehicle body and grounded. The negative electrode terminal of the first battery 13 is connected to the positive electrode terminal of the second battery 14 via the series line 35. A series relay Rs is attached to the series line 35. Therefore, the first battery 13 and the second battery 14 are connected in series to each other by turning on the series relay Rs.

The motor 20 is configured as a three-phase AC motor having, for example, a rotor in which a permanent magnet is embedded in a rotor core, and a stator in which a three-phase (U-phase, V-phase, and W-phase) coil is wound around the stator core. The first inverter 22 includes six transistors T11 to T16 as switching elements, and six diodes D11 to D16 connected in parallel to each of the six transistors T11 to T16. The transistors T11 to T16 are arranged in pairs so as to be source-side and sink-side with respect to the first positive electrode line 31 and the negative electrode line 33, respectively. Each of the connecting points of the two transistors that form a pair of the transistors T11 to T16 is connected to one end of a three-phase (U-phase, V-phase, and W-phase) coil of the motor 20. A first capacitor 26 for smoothing is connected to the first positive electrode line 31 and the negative electrode line 33. Like the first inverter 22, the second inverter 24 includes six transistors T21 to T26 as switching elements and six diodes D21 to D26. The transistors T21 to T26 are arranged in pairs so as to be source-side and sink-side with respect to the second positive electrode line 32 and the negative electrode line 33, respectively. Each of the connecting points of the two transistors that are the pair of the transistors T21 to T26 is connected to the other end of the three-phase (U-phase, V-phase, and W-phase) coil of the motor 20. A second capacitor 28 for smoothing is connected to the second positive electrode line 32 and the negative electrode line 33. The first positive electrode line 31 and the second positive electrode line 32 are connected by a positive electrode connection line Lp. A positive electrode connection relay Rc1 is connected to the positive electrode connection line Lp. The positive electrode connection relay Rc1 includes two transistors T31, T32 as switching elements and two diode D31, D32 connected in parallel to the two transistors T31, T32. A negative electrode connection relay Rc2 is connected between the first inverter 22 and the second inverter 24 of the negative electrode line 33. The negative connection relay Rc2 disconnects and connects the negative terminal of the second battery 14 and the negative power supply line of the second inverter 24. Hereinafter, T23 from the transistor T11 to 13, T21 of the first and second inverters 22 and 24 may be referred to as an "upper arm", and T26 from the transistor T14 to T16, T24 may be referred to as a "lower arm".

The switching circuit 30 includes the first positive electrode line 31, the second positive electrode line 32, the negative electrode line 33, the series line 35, and the series relay Rs. In addition, the switching circuit 30 includes a parallel line 36, a first parallel relay Rp1, a second parallel relay (second positive electrode relay) Rp2, a positive electrode relay (first positive electrode relay) Rp3, and a negative relay Rp4. The parallel line 36 connects the negative electrode terminal of the first battery 13 and the negative electrode line 33. The first parallel relay Rp1 is attached to the parallel line 36. The second parallel relay Rp2 is attached to the second positive electrode line 32. The positive electrode relay Rp3 is attached to the first battery 13 from the first inverter 22 and the second inverter 24 of the first positive electrode line 31, and connects and disconnects the first battery 13, the first inverter 22, and the first capacitor 26. The negative electrode relay Rp4 is attached to the first battery 13 from the first inverter 22 and the second inverter 24 of the negative electrode line 33.

The charging circuit 40 includes a charging line 42 connected to the first positive electrode line 31 and the negative electrode line 33, and a charging connector 44 connected to the charging line 42. The charging connector 44 is configured to be connectable to the stand connector 82 of the charging station 80.

The system ECU 50 includes a CPU, a ROM, RAM, a flash memory, an input/output port, a microcomputer having a communication port, various driving circuits, and various logic IC. The system ECU 50 receives signals from various sensors. Examples of the various sensors include a voltage sensor 13v that detects a voltage Vb1 of the first battery 13, and a temperature sensor 13t that detects a temperature Tb1 of the first battery 13. Examples of the various sensors include a voltage sensor 14v that detects a voltage Vb2 of the second battery 14, and a temperature sensor 14t that detects a temperature Tb2 of the second battery 14. Examples of the various sensors include a rotational position sensor 20a that detects the rotational position of the rotor of the motor 20, and a current sensor 20u, 20v, 20w that detects Iu, Iv, Iw of current flowing in each phase (U-phase, V-phase, and W-phase) of the motor 20. Examples of the various sensors include a voltage sensor 26v that detects the voltage VH of the first capacitor 26 and a voltage sensor 28v that detects the voltage VL of the second capacitor 28. Further, a current sensor 31i for detecting a current Ip1 flowing through the first positive electrode line 31 and a current sensor 32i for detecting a current Ip2 flowing through the second positive electrode line 32 are also exemplified. When the series relay Rs and the positive electrode connection relay Rc1 are in the off-state and the first parallel relay Rp1, the second parallel relay Rp2, the positive electrode relay Rp3, the negative relay Rp4, and the negative electrode connection relay Rc2 are in the on-state, the following occurs. That is, the first battery 13 is connected to the first positive electrode line 31 and the negative electrode line 33, and the second battery 14 is connected to the second positive electrode line 32 and the negative electrode line 33. At this time, the current Ip1 flowing through the first positive electrode line 31 is equal to the current flowing through the first battery 13, and the current Ip2 flowing through the second positive electrode line 32 is equal to the current flowing through the second battery 14. When the series relay Rs, the positive electrode relay Rp3, the negative-electrode relay Rp4, and the negative electrode connection relay Rc2 are in the ON state and the first parallel relay Rp1, the second parallel relay Rp2, and the positive electrode connection relay Rc1 are in the OFF state, the following occurs. That is, the first battery 13 and the second battery 14 are connected in series. At this time, the current Ip1 flowing through the first positive electrode line 31 is equal to the current flowing through the first battery 13 and the second battery 14.

The system ECU 50 calculates the power storage ratio SOC1, SOC2, the open-circuit voltage OCV1, OCV2, and the allowable-input power Win1, Win2 of the first battery 13 and the second battery 14. The power storage ratio SOC1, SOC2 is calculated based on, for example, the first integrated value, the second integrated value, and the third integrated value. The first integrated value and the second integrated value are, for example, integrated values of the integrated value of the current Ip1 (current flowing through the first battery 13) flowing through the first positive electrode line 31 and the integrated value of the current Ip2 (current flowing through the second battery 14) flowing through the second positive electrode line 32 in the following conditions. In this state, the series relay Rs and the positive electrode connection relay Rc1 are in the off-state, and the first parallel relay Rp1, the second parallel relay Rp2, the positive electrode relay Rp3, the negative-electrode relay Rp4, and the negative electrode connection relay Rc2 are in the on-state. The third integrated value is, for example, an integrated value of the current Ip1 (current flowing through the first battery 13 and the second battery 14) flowing through the first positive electrode line 31 in the following condition. In this state, the series relay Rs, the positive electrode relay Rp3, the negative-electrode relay Rp4, and the negative electrode connection relay Rc2 are in the ON state, and the first parallel relay Rp1, the second parallel relay Rp2, and the positive electrode connection relay Rc1 are in the OFF state. The open-circuit voltage OCV1, OCV2 is derived, for example, by applying the power storage ratio SOC1, SOC2 to a map determined in advance by experimentation, analysis, machine-learning, or the like as a relation between the power storage ratio SOC1, SOC2 and the open-circuit voltage OCV1, OCV2. The allowable input-power Win1, Win2 is derived, for example, by applying the power storage ratio SOC1, SOC2 and the thermal Tb1, Tb2 to a predetermined map. The predetermined map is determined in advance by experimentation, analysis, machine learning, or the like as a relation between the power storage ratio SOC1, SOC2, the temperature Tb1, Tb2, and the allowable input-power Win1, Win2.

A control signal to the first and second inverters 22 and 24 and a control signal to the relays are outputted from the system ECU 50. Examples of the relays include a series relay Rs, a first parallel relay Rp1, a second parallel relay Rp2, a positive electrode relay Rp3, a negative relay Rp4, a positive electrode connection relay Rc1, and a negative electrode connection relay Rc2. The system ECU 50 can communicate with a stand electronic control unit (hereinafter, referred to as a "stand ECU") 86 of the charging station 80.

The charging station 80 includes a stand connector 82, a power supply device 84, and a stand ECU 86. The stand connector 82 is configured to be connectable to the charging connector 44 of the power supply system 10. The power supply device 84 is connected to an AC power source such as a household power source or a commercial power source, and is configured to be capable of converting AC power from the AC power source into DC power and adjusting output power (output voltage and output current) so as to be output to the stand connector 82 side. The stand ECU 86 comprises a microcomputer as well as a system ECU 50. The stand ECU 86 receives signals of various sensors. Examples of the various sensors include a voltage sensor (not shown) that detects an output voltage Vs of the power supply device 84, and a current sensor (not shown) that detects an output current Is of the power supply device 84. A control signal to the power supply device 84 is outputted from the stand ECU 86. The stand ECU 86 is capable of communicating with the system ECU 50 as described above. Examples of the charging station 80 include a first voltage stand in which the voltage of the supply power is a first voltage Vs1 (e.g., 400V), and a second voltage stand in which the voltage of the supply power is a second voltage Vs2 (e.g., 800V) higher than the first voltage Vs1. Further, the charging station 80 may be a third voltage station capable of selectively setting either the first voltage Vs1 or the second voltage Vs2 as the voltage of the supplied power.

In the power supply system 10 of the embodiment configured as described above, when the motor 20 is traveled as a traveling motor, the following is performed. That is, the series relay Rs, the positive electrode relay Rp3, the negative relay Rp4, and the negative electrode connection relay Rc2 are turned on, and the first parallel relay Rp1, the second parallel relay Rp2, and the positive electrode connection relay Rc1 are turned off. In this way, the first battery 13 and the second battery 14 are connected in series, and the motor 20 is driven by the first inverter 22 using electric power from the first battery 13 and the second battery 14.

Further, in the power supply system 10, the system ECU 50 selects parallel charging when the voltage of the supplied power of the charging station 80 is the first voltage Vs1 when the charging connector 44 and the stand connector 82 of the charging station 80 are connected. The system ECU 50 selects the series charge when the voltage of the supplied power of the charging station 80 is the second voltage Vs2 when the charging connector 44 and the stand connector 82 of the charging station 80 are connected.

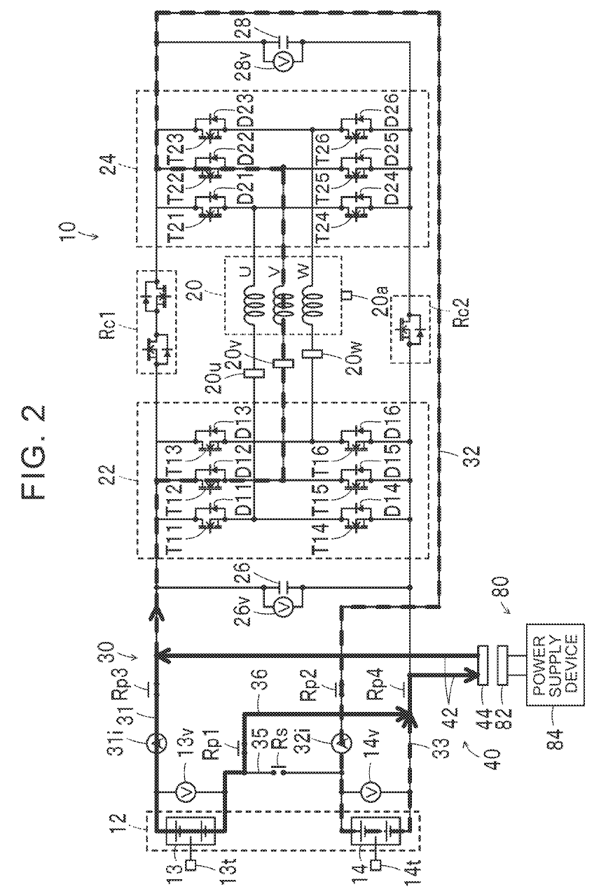

In parallel charging, the series relay Rs and the positive electrode connection relay Rc1 are turned off, and the first parallel relay Rp1, the second parallel relay Rp2, the positive electrode relay Rp3, the negative relay Rp4, and the negative electrode connection relay Rc2 are turned on. In this way, the first battery 13 and the second battery 14 are connected in parallel as viewed from the charging connector 44, and the first battery 13 and the second battery 14 are charged using the electric power from the charging station 80. FIG. 2 is an explanatory diagram illustrating a current path during parallel charging. In the drawing, a thick solid line with an arrow indicates a charging current of the first battery 13, and a thick broken line indicates a charging current of the second battery 14. In parallel charging, the first battery 13 is charged by a current flowing in the order indicated by a thick solid line with an arrow in FIG. 2. The current flows from the charging connector 44 to the positive electrode line of the charging line 42. The current flows to the first positive electrode line 31 (positive electrode relay Rp3), the first battery 13, the parallel line 36 (first parallel relay Rp1), the negative electrode line 33 (negative electrode relay Rp4), the negative electrode line of the charging line 42, and the charging connector 44. The second battery 14 is charged by a current flowing in order as indicated by a thick broken line with an arrow in FIG. 2. The current flows from the charging connector 44 to the positive electrode line of the charging line 42. The current flows to the first positive electrode line 31, the first inverter 22, the motor 20, and the second inverter 24. The current flows to the second positive electrode line 32 (second parallel relay Rp2), the second battery 14, the negative electrode line 33 (negative electrode relay Rp4), the negative electrode line of the charging line 42, and the charging connector 44. At this time, the upper arm of the second inverter 24 is turned on and fixed (the lower arm is turned off and fixed), and a step-down control for controlling the duty of the upper arm and the lower arm of the first inverter 22 is executed. In this way, the motor 20 and the first inverter 22 function as a three-phase step-down converter, and the input power of the first inverter 22 is stepped down and output from the motor 20. Further, the upper arm of the first inverter 22 is turned on and fixed (the lower arm is turned off and fixed), and the boost control for controlling the duty of the upper arm and the lower arm of the second inverter 24 is executed. In this way, the motor 20 and the second inverter 24 function as a three-phase boost converter, and the input power of the motor 20 is boosted and output from the second inverter 24.

In the series charge, the series relay Rs, the positive electrode relay Rp3, the negative relay Rp4, and the negative electrode connection relay Rc2 are turned on, and the first parallel relay Rp1, the second parallel relay Rp2, and the positive electrode connection relay Rc1 are turned off. In this way, the first battery 13 and the second battery 14 are connected in series, and the first battery 13 and the second battery 14 are charged using the electric power from the charging station 80. In the series charging, the first battery 13 and the second battery 14 are charged by the current flowing in the following order. That is, the current flows from the charging connector 44 to the positive electrode line of the charging line 42, the first positive electrode line 31, the first battery 13, the series line 35 (series relay Rs), and the second battery 14. The current flows to the negative electrode line 33 (negative electrode relay Rp4), the negative electrode line of the charging line 42, and the charging connector 44.

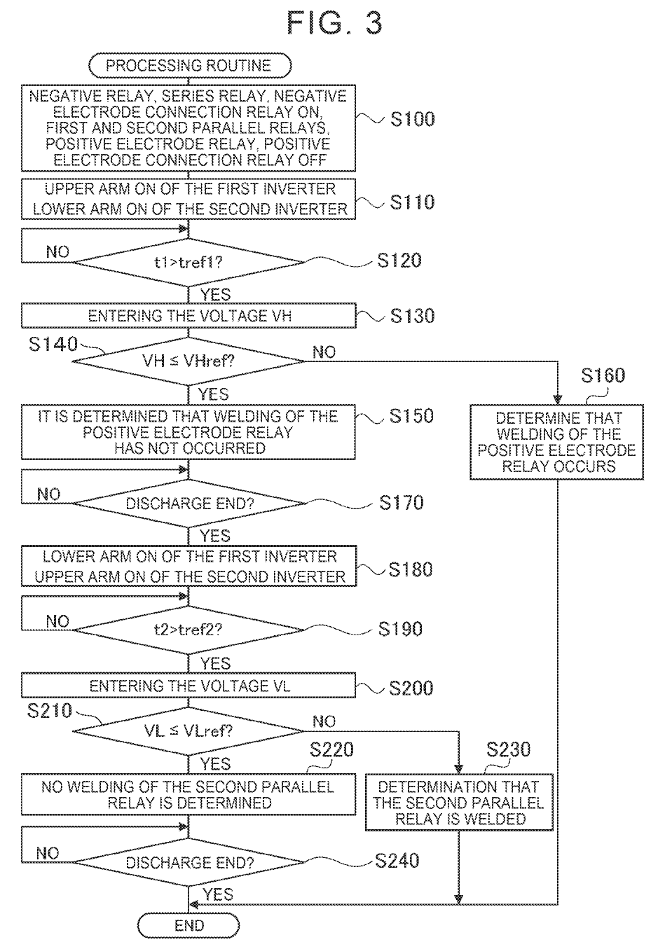

Next, the operation of the power supply system 10 of the embodiment, in particular, the operation when discharging the first and second capacitors 26 and 28 after the parallel charging or the series charging is completed will be described. FIG. 3 is a flowchart illustrating a process routine executed by the system ECU 50. This routine is executed after parallel charging or series charging is completed. Before the execution of this routine is started, the connection between the charging connector 44 and the stand connector 82 of the charging station 80 is released.

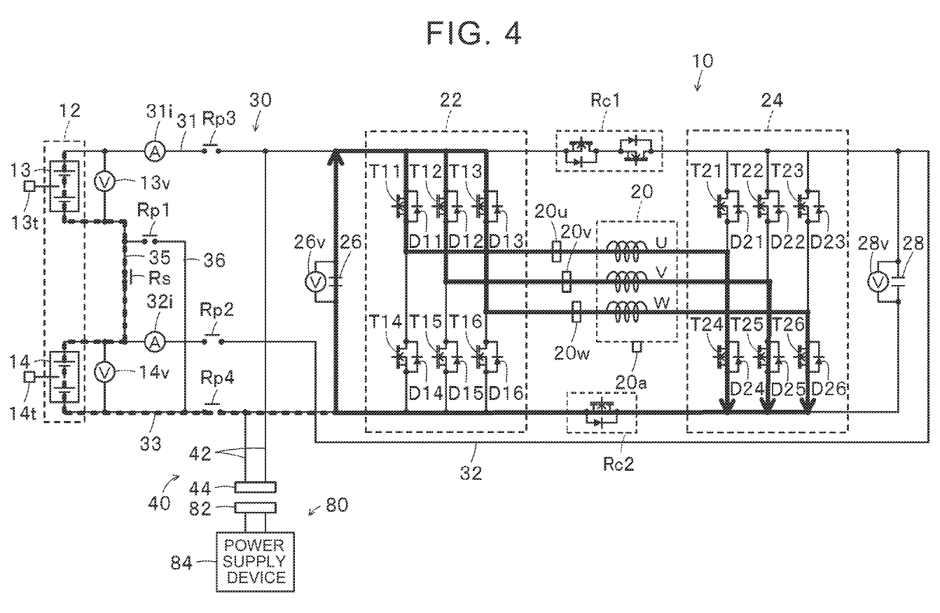

When this routine is executed, the system ECU 50 controls the negative relay Rp4, the negative electrode connection relay Rc2, the series relay Rs, the first and second parallel relay Rp1, Rp2, the positive electrode relay Rp3, and the positive electrode connection relay Rc1 (S100). That is, the system ECU 50 controls the negative relay Rp4, the series relay Rs, and the negative electrode connection relay Rc2 to be in the ON state, and controls the first and second parallel relays Rp1, Rp2, the positive electrode relay Rp3, and the positive electrode connection relay Rc1 to be in the OFF state. The system ECU 50 turns on and fixes the upper arm of the first inverter 22 (turns off and fixes the lower arm) and turns on and fixes the lower arm of the second inverter 24 (turns off and fixes the upper arm) (S110). Further, the system ECU 50 determines whether or not the elapsed time t1 since the on-fixing of the lower arm of the second inverter 24 is started together with the on-fixing of the upper arm of the first inverter 22 has elapsed a predetermined time tref1 (S120). The predetermined time tref1 is a time determined in advance by experimentation, analysis, or machine-learning. The predetermined time tref1 is a predetermined time as a time required for the voltage of the first capacitor 26 to decrease after the on-fixing of the upper arm of the first inverter 22 and the on-fixing of the lower arm of the second inverter 24 are started. The predetermined time tref1 is a time predetermined as a time required for the voltage of the first capacitor 26 to decrease to the extent that it can be determined whether or not the voltage of the first capacitor 26 decreases. FIG. 4 is an explanatory diagram illustrating a current path when the upper arm of the first inverter 22 is turned on and fixed and the lower arm of the second inverter 24 is turned on and fixed when welding is not occurring in the positive-electrode-relay Rp3. In the drawing, a thick solid line with an arrow indicates a path of a current when discharging the first capacitor 26, and a thick broken line indicates a connection between the first and second batteries 13 and 14 and the power supply lines of the first and second inverters 22 and 24. As shown in FIG. 4, when the positive electrode relay Rp3 is normal, a current flows in the order of the upper arm of the first inverter 22, the lower arm of the motor 20 and the second inverter 24, and the first capacitor 26. Due to the resistance of the winding of the motor 20, the first capacitor 26 is discharged, and the voltage of the first capacitor 26 gradually decreases. At this time, since the negative terminal of the second battery 14 is connected to the negative power supply lines of the first and second inverters 22 and 24, the first capacitor 26 can be discharged while the potentials of the first and second inverters 22 and 24 are stabilized. Thus, stable discharge of the first capacitor 26 can be performed.

When the elapsed time t1 has passed the predetermined time tref1, the system ECU 50 receives the voltage VH of the first capacitor 26 from the voltage sensor 26v (S130). Then, the system ECU 50 determines whether or not the input voltage VH is equal to or less than the determination value VHref (S140). The determination value VHref is a threshold value for determining whether or not the voltage VH is significantly decreased. The determination value VHref is set to, for example, a voltage obtained by subtracting a predetermined voltage (for example, 50V or the like) from the voltage VH of the first capacitor 26 detected by the voltage sensor 26v when the routine is started. When welding occurs in the positive electrode relay Rp3, that is, when the positive electrode relay Rp3 is on-fixed. At this time, a voltage when the first battery 13 and the second battery 14 are connected in series to the first capacitor 26 is applied, and the first capacitor 26 cannot be discharged. In this case, the voltage of the first capacitor 26 does not decrease. Therefore, S140 is a process for determining whether or not welding has occurred in the positive electrode-relay Rp3.

When the voltage VH is equal to or lower than the determination value VHref in S140, the system ECU 50 determines that welding of the positive electrode relay Rp3 has not occurred (S150), and executes the processes after S170. When the voltage VH exceeds the determination value VHref in S140, it is determined that welding of the positive electrode relay Rp3 has occurred (S160), and this routine is ended. By this process, it is possible to determine whether or not welding of the positive electrode-relay Rp3 has occurred while stably discharging the first capacitor 26.

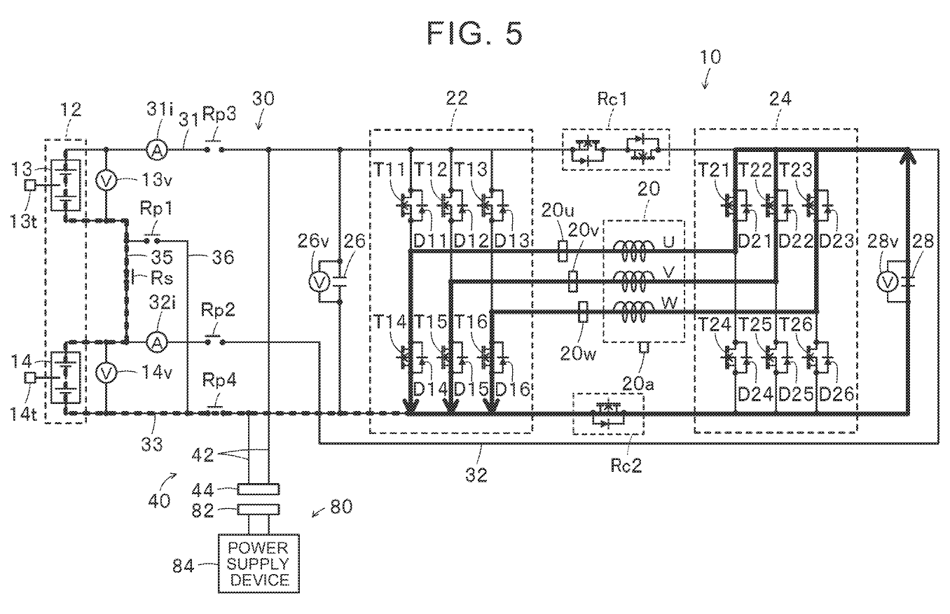

If it is determined that the positive-electrode-relay Rp3 has not been welded in S150, the system ECU 50 waits until the discharging of the first capacitor 26 is completed (S170). Whether or not the discharge of the first capacitor 26 is completed, the voltage VH of the first capacitor 26 is input from the voltage sensor 26v, it is determined whether or not the voltage VH becomes the value 0, and it is determined that the discharge of the first capacitor 26 is completed when the voltage VH becomes the value 0. When the discharging of the first capacitor 26 is completed in S170, a S180 is obtained. The system ECU 50 turns on and fixes the lower arm of the first inverter 22 (turns off and fixes the upper arm) and turns on and fixes the upper arm of the second inverter 24 (turns off and fixes the lower arm) (S180). Further, the system ECU 50 determines whether or not the elapsed time t2 since the on-fixing of the lower arm of the first inverter 22 and the on-fixing of the upper arm of the second inverter 24 have elapsed a predetermined time tref2 (S190). The predetermined time tref2 is a time determined in advance by experimentation, analysis, or machine-learning. The predetermined time tref2 is a predetermined time as a time required for the voltage of the second capacitor 28 to decrease after the on-fixing of the lower arm of the first inverter 22 and the on-fixing of the upper arm of the second inverter 24 are started. The predetermined time tref2 is a time predetermined as a time required for the voltage of the second capacitor 28 to decrease to the extent that it can be determined whether or not the voltage of the second capacitor 28 has decreased. FIG. 5 is an explanatory diagram showing a current path when the lower arm of the first inverter 22 is turned on and fixed and the upper arm of the second inverter 24 is turned on and fixed when welding is not occurring in the second parallel relay Rp2. In the drawing, a thick solid line with an arrow indicates a path of a current when discharging the second capacitor 28, and a thick broken line indicates a connection between the first and second batteries 13 and 14 and the power supply lines of the first and second inverters 22 and 24. As shown in FIG. 5, when the second parallel relay Rp2 is normal, a current flows in the order of the upper arm of the second inverter 24, the motor 20, the lower arm of the first inverter 22, and the second capacitor 28. Due to the resistance of the winding of the motor 20, the second capacitor 28 is discharged, and the voltage of the second capacitor 28 gradually decreases. At this time, since the negative terminal of the second battery 14 is connected to the negative power supply lines of the first and second inverters 22 and 24, the second capacitor 28 can be discharged while the potentials of the first and second inverters 22 and 24 are stabilized. Thus, stable discharge of the second capacitor 28 can be performed.

When the elapsed time t2 has passed the predetermined time tref2, the system ECU 50 receives the voltage VL of the second capacitor 28 from the voltage sensor 28v (S200). Then, the system ECU 50 determines whether or not the input voltage VL is equal to or less than the determination value VLref (S210). The determination value VLref is a threshold value for determining whether or not the voltage VL is significantly decreased. The determination value VLref is set to, for example, a voltage obtained by subtracting a predetermined voltage (for example, 50V or the like) from the voltage VL of the second capacitor 28 detected by the voltage sensor 28v when the routine is started. When welding occurs in the second parallel relay Rp2, that is, when the second parallel relay Rp2 is fixed. At this time, the voltage between terminals of the second battery 14 is applied to the second capacitor 28, so that the second capacitor 28 cannot be discharged, and the voltage of the second capacitor 28 does not decrease. Therefore, S210 is a process of determining whether or not welding has occurred in the second parallel-use relay Rp2.

When the voltage VL is equal to or lower than the determination value VLref in S210, the system ECU 50 determines that welding of the second parallel relay Rp2 has not occurred (S220), and executes S240 process. When the voltage VL exceeds the determination value VLref in S210, it is determined that welding of the second parallel relay Rp2 has occurred (S230), and the routine ends. By such a process, it is possible to determine whether or not welding of the second parallel-relay Rp2 has occurred while stably discharging the second capacitor 28.

When the system ECU 50 determines that welding of the second parallel-relay Rp2 has not occurred in S220, it waits until discharging of the second capacitor 28 is completed (S240). In S240, the system ECU 50 determines that the discharging of the second capacitor 28 is completed when the voltage VL from the voltage sensor 28v becomes 0, and ends the routine.

In the power supply system 10 of the above-described embodiment, when the first and second capacitors 26 and 28 are discharged, the first capacitor 26 or the second capacitor 28 can be stably discharged by turning on the negative-electrode connecting-relay Rc2.

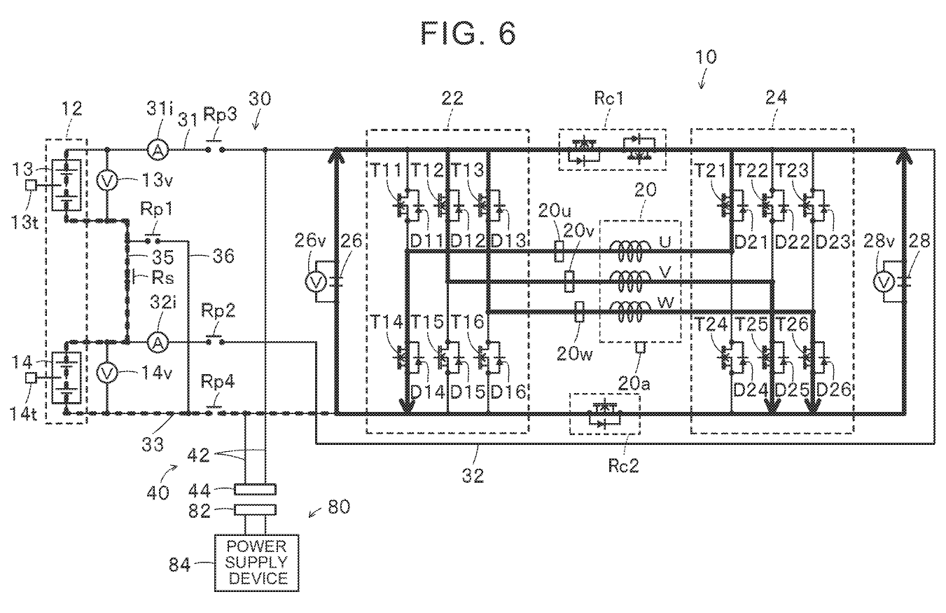

In the above-described embodiment, when the first and second capacitors 26 and 28 are discharged, the positive electrode connecting-relay Rc1 is turned off. However, the positive-connection-relay Rc1 may be turned on. When discharging the first and second capacitors 26 and 28, the negative-electrode relay Rp4, the series relay Rs, the positive electrode connection relay Rc1, the negative electrode connection relay Rc2, the first and second parallel relay Rp1, Rp2, and the positive electrode relay Rp31 are controlled. Thus, the first and second inverters 22 and 24 may be PWM controlled. That is, the negative relay Rp4, the series relay Rs, the positive electrode connection relay Rc1, and the negative electrode connection relay Rc2 are turned on, and the first and second parallel relays Rp1, Rp2 and the positive electrode relay Rp31 are turned off. FIG. 6 is an explanatory diagram illustrating an exemplary current path when PWM of the first and second inverters 22 and 24 are controlled. In the drawing, a thick solid line with an arrow indicates a current path, and a thick broken line indicates a connection between the first and second batteries 13 and 14 and the power supply lines of the first and second inverters 22 and 24. As shown in FIG. 6, since a current flows between the first inverter 22 and the second inverter 24 via the motor 20, the first and second capacitors 26 and 28 are discharged by the resistance of the winding of the motor 20. At this time, since the negative electrode terminal of the second battery 14 is connected to the negative power supply lines of the first and second inverters 22 and 24, the first and second capacitors 26 and 28 can be discharged in a state where the potentials of the first and second inverters 22 and 24 are stabilized. Thus, stable discharge of the first and second capacitors 26 and 28 can be performed. Also in this case, it may be determined whether or not welding has occurred in the positive electrode relay Rp3 based on the voltage VH, or it may be determined whether or not welding has occurred in the second parallel relay Rp2 based on the voltage VL.

In the above-described embodiment, the positive electrode connection relay Rc1 and the negative electrode connection relay Rc2 are provided with transistors as switching elements. However, the positive electrode connection relay Rc1 and the negative electrode connection relay Rc2 may be mechanically switched on and off instead of the transistor.

Although the embodiments for carrying out the present disclosure have been described above, the present disclosure is not limited to such embodiments at all, and it is needless to say that the present disclosure can be carried out in various forms without departing from the gist of the present disclosure.

The present disclosure is applicable to a manufacturing industry of a power supply system and the like.

What is claimed is:

1. A power supply system including a first battery and a second battery, the power supply system comprising:
a motor including a three-phase coil;
a first inverter connected to the first battery via a first positive electrode line and a negative electrode line and connected to one end side of the three-phase coil;
a second inverter connected to the second battery via a second positive electrode line and the negative electrode line and connected to another end side of the three-phase coil;
a first capacitor connected to the first positive electrode line and the negative electrode line;
a second capacitor connected to the second positive electrode line and the negative electrode line;
a negative electrode connection relay that is attached to the negative electrode line and that enables and disables connection between a negative electrode terminal of the second battery and a negative side power supply line of the second inverter;
a charging connector connected to the first positive electrode line and the negative electrode line and electrically connectable to a charging facility; and
a control device that turns on the negative electrode connection relay when discharging the first capacitor or the second capacitor.

2. The power supply system according to claim 1, further comprising:
a first positive electrode relay that is attached to the first positive electrode line and that enables and disables connection between the first battery and the first inverter and the first capacitor; and
a second positive electrode relay that is attached to the second positive electrode line and that enables and disables connection between the second battery and the second inverter and the second capacitor, wherein
when discharging the first capacitor, the control device turns on and fixes an upper arm of the first inverter and turns off and fixes a lower arm of the second inverter in a state in which the first and second positive electrode relays are turned off and the negative electrode connection relay is turned on, and when discharging the second capacitor, the control device turns on and fixes a lower arm of the first inverter and turns off and fixes an upper arm of the second inverter in a state in which the first and second positive electrode relays are turned off and the negative electrode connection relay is turned on.

3. A power supply system including a first battery and a second battery, the power supply system comprising:
a motor including a three-phase coil;
a first inverter connected to the first battery via a first positive electrode line and a negative electrode line and connected to one end side of the three-phase coil;
a second inverter connected to the second battery via a second positive electrode line and the negative electrode line and connected to another end side of the three-phase coil;
a first capacitor connected to the first positive electrode line and the negative electrode line;
a second capacitor connected to the second positive electrode line and the negative electrode line;
a positive electrode connection relay attached to a positive electrode connection line that connects the first positive electrode line and the second positive electrode line;
a negative electrode connection relay that is attached to the negative electrode line and that enables and disables connection between a negative electrode terminal of the second battery and a negative side power supply line of the second inverter;
a first positive electrode relay that is attached to the first positive electrode line and that enables and disables connection between the first battery and the first inverter and the first capacitor;
a second positive electrode relay that is attached to the second positive electrode line and that enables and disables connection between the second battery and the second inverter and the second capacitor;
a charging connector connected to the first positive electrode line and the negative electrode line and electrically connectable to a charging facility; and
a control device that turns off the first and second positive electrode relays and turns on the positive electrode connection relay and the negative electrode connection relay when discharging the first capacitor and the second capacitor.

4. The power supply system according to claim 3, wherein the control device performs pulse width modulation (PWM) control on the first and second inverters in a state in which the first and second positive electrode relays are turned off and the positive electrode connection relay and the negative electrode connection relay are turned on.

5. The power supply system according to claim 2, wherein the control device determines whether welding has occurred in at least one of the first and second positive electrode relays based on a voltage of the first capacitor or the second capacitor when being discharged.

6. The power supply system according to claim 3, wherein the control device determines whether welding has occurred in at least one of the first and second positive electrode relays based on a voltage of the first capacitor or the second capacitor when being discharged.
